(19) United States
(12) Patent Application Publication
(10) Pub. No.: US 2017/0086044 A1
(43) Pub. Date: Mar. 23, 2017

(54) MOBILE WIRELESS CONNECTIVITY ADVERTISING PLATFORM

(71) Applicants: Joseph Spina, Sarasota, FL (US); Andrew Pilz, Sarasota, FL (US)

(72) Inventors: Joseph Spina, Sarasota, FL (US); Andrew Pilz, Sarasota, FL (US)

(21) Appl. No.: 15/122,364

(22) PCT Filed: Mar. 2, 2015
(86) PCT No.: PCT/US15/18308

§ 371 Date: Aug. 29, 2016

Related U.S. Application Data
(60) Provisional application No. 61/946,265, filed on Feb. 28, 2014.

(51) Int. Cl. H04W 4/20; H04L 29/08; H04M 1/725; H04W 4/00

(52) U.S. Cl. CPC H04W 4/206; H04W 4/008; H04L 67/1097; H04M 1/72572; H04W 88/10

(57) ABSTRACT

A long-range Wi-Fi/Bluetooth communication device for delivering content in a network communication system to mobile devices. The device includes at least one Wi-Fi communication module and at least one Bluetooth communication module connected to the control module. The device further includes a network interface connected to the control module, the network interface being configured to transmit and receive content data to and from the network communication system. There is at least one antenna configured to transmit radio frequency signals to the mobile devices and receive radio frequency signals from the mobile devices. The at least one antenna is connected to pass the radio frequency signals to and from the at least one Wi-Fi communication module and the at least one Bluetooth communication module. Both the at least one Wi-Fi communication module and the at least one Bluetooth communication module have a maximum range of at least 400 m.

### CROSS REFERENCE TO RELATED APPLICATION

This application claims the benefit of U.S. Provisional Patent Application No. 61/946,265, filed on Feb. 28, 2014, which is hereby incorporated by reference in its entirety.

### FIELD OF THE INVENTION

The disclosed embodiments relate to a network communication system and method for delivering content to mobile devices using long-range Wi-Fi/Bluetooth communication devices. The long-range Wi-Fi/Bluetooth communication devices each include a network communication interface, at least one Wi-Fi transmitter, and at least one Bluetooth transmitter.

### BACKGROUND

Advertisements for goods and services have long provided value to businesses that utilizes advertisements. By providing targeted advertisements, businesses have increased their profitability, while also providing advertisements targeted based on a user's search habits. However, such targeting, data collection, and monitoring have raised significant ethical issues and consumers are weary of the possibility of “big brother” watching a user's search habits.

Mobile devices, including phones, tablets, laptops, and other similar devices commonly use wireless Internet access at various wireless access points (WAPs), commonly referred to as Wi-Fi access points to access the internet, email, and other online aspects. However, access is often limited in public areas, and access for consumers in public areas often comes with steep fees.

Wi-Fi access is typically expensive because of the costs related to setting up and maintaining the infrastructure. Furthermore, maintenance does not simply involve hardware and software but also the requirements to generate, store, and maintain user accounts, user authorizations, usage metering, billing, support, among other requirements for the system. Accordingly, infrequent users and single-use customers, such as mobile based customers, often face steep fees and frustration in accessing the internet when away from their home or office. Improved systems for internet access are required that eliminate some of these fees while provided for maintenance of the Wi-Fi systems through other forms of compensation.

Furthermore, there are presently hundreds of millions BLUETOOTH devices sold worldwide capable of using Bluetooth Wireless Access Points (BWAPs). The problem is that these BWAP's are not integrated with Wi-Fi networks, or coordinated to provide free access in current systems. Nor are these BWAP's currently being utilized for advertising platforms.

The prior art includes some attempts at mobile advisements using various mechanisms to target consumers based on the location of the user. This is in contrast to most advertising that is targeted based on a user's search history on the internet, or interests based on a profile on a social network. Accordingly, U.S. Pat. No. 7,343,317 provides a method of distributing messages to a mobile terminal wherein a user registers with a system and grants permission to said system to receive advertisements.

Similarly, U.S. Pat. No. 7,920,849 provides a method of placing advertisements in a user's view of a cell phone or other Bluetooth equipped device by accessing a Bluetooth wireless access point.

Similarly, U.S. Pub. No. 2003/0006911 provides for an interactive advertising system and method for providing multimedia content to a handheld device.

However, these systems require either registration with a system, or intrusive applications within a mobile user's phone, which are a concern for users of these mobile devices with regard to the privacy of their devices. Many mobile users are increasingly suspect of how their data and information is being utilized, stored, sold, or otherwise compiled. New systems and methods of using these systems are now needed to move the advertising platform forward with regard to penetration and social acceptance.

### SUMMARY

The disclosed embodiments provide a long-range Wi-Fi/Bluetooth communication device for delivering content in a network communication system to mobile devices. The device includes a control module comprising a processor and memory; at least one Wi-Fi communication module connected to the control module, the Wi-Fi communication module comprising a transmitter and a receiver; and at least one Bluetooth communication module connected to the control module, the Bluetooth communication module comprising a transmitter and a receiver. The device further includes a network interface connected to the control module, the network interface being configured to transmit and receive content data to and from the network communication system. There is at least one antenna configured to transmit radio frequency signals to the mobile devices and receive radio frequency signals from the mobile devices. The at least one antenna is connected to pass the radio frequency signals to and from the at least one Wi-Fi communication module and the at least one Bluetooth communication module. Both the at least one Wi-Fi communication module and the at least one Bluetooth communication module have a maximum range of at least 400 m.

The disclosed embodiments further provide a network communication system for delivering content to mobile devices. The system includes a number of long-range Wi-Fi/Bluetooth communication devices connected to a network and a control server connected to the communication devices via the network. The control server includes a database for storing content to be delivered to the mobile devices and is configured to present a user interface via the network.

The disclosed embodiments further provide a method of delivering content from a network communication system to mobile devices using a long-range Wi-Fi/Bluetooth communication device having a control module including a processor and memory, at least one Wi-Fi communication module connected to the control module, at least one Bluetooth communication module connected to the control module. The method includes transmitting Wi-Fi and Bluetooth radio frequency signals through at least one antenna to the mobile devices at a maximum range of at least 400 m. The at least one antenna is connected to pass the radio frequency signals to and from the at least one Wi-Fi communication module and the at least one Bluetooth communication module. The method further includes receiving radio frequency signals from the mobile devices; sending, by the Wi-Fi communication module, a connection acceptance to the mobile devices from which a Wi-Fi access request is received in the received radio frequency signals; sending, by the Bluetooth communication module, a pairing message to the mobile devices from which a Bluetooth pairing request is received in the received radio frequency signals to establish pairing unless a Wi-Fi connection is already established with the Bluetooth-pairing mobile device; receiving, by the Bluetooth communication module, a pairing acceptance from the Bluetooth-pairing mobile device, the pairing acceptance comprising an identifier of the Bluetooth-pairing mobile device; and sending, by the Bluetooth communication module, to the Bluetooth pairing mobile device, content retrieved from the memory of the communication device.

Embodiments of the present disclosure relate to advertising systems comprising a server, data, wireless connectivity means, Bluetooth connectivity means, and a mobile device, wherein a mobile device searching for a wireless connectivity link connects to the free wireless service, which provides for advertisements to said mobile device in exchange for the free wireless; and wherein no wireless connectivity is present on said mobile device, a second means of connecting provides for Bluetooth connectivity with a message incorporating said advertisement in a connecting message.

Further embodiments of the present disclosure include a method of advertising on wireless devices comprising activating a Wi-Fi or Bluetooth network, wherein said networks have a geofence; communicating with an enabled wireless device that is within said geofence through a first Wi-Fi connection to send an advertisement; and if said Wi-Fi connection is not accepted by said user, sending a second notification via Bluetooth comprising a message of no more than 16 characters to said user wireless device.

Further embodiments of the present disclosure include a method of advertising on wireless devices comprising activating a Wi-Fi or Bluetooth network, wherein said networks have a geofence; accessing, via a first wireless device the Wi-Fi network; providing a splash screen to said wireless device; enabling internet connection to said wireless device after said splash screen has been viewed.

Further embodiments of the present disclosure include a method of advertising on wireless devices comprising activating a Wi-Fi or Bluetooth network, wherein said networks have a geofence; accessing, via a first wireless device the Wi-Fi network; providing a splash screen to said wireless device; enabling internet connection to said wireless device after said splash screen has been viewed; if said wireless device is not capable of connecting to said Wi-Fi network, providing a second connectivity access via Bluetooth comprising a message to said user wireless device.

An advertising system comprising a processor and memory and a wireless antenna capable of providing a wireless network for Wi-Fi or Bluetooth over a given range; wherein the system provides a Wi-Fi network free of charge within a given range, having a geofence; and wherein a device capable of connecting to said Wi-Fi network attempts to connect to the Wi-Fi network, and a splash screen is first prompted to the device wherein advertisements stored within the memory are provided on the splash screen before the device is connected to the internet.

An advertising system comprising a processor and memory and a wireless antenna capable of providing a wireless network for Wi-Fi and Bluetooth over a given range; wherein the system provides a Wi-Fi network free of charge to a given range, having a geofence and a Bluetooth network within about the same range; and wherein a device capable of connecting to said Wi-Fi network first attempts to connect to the Wi-Fi network; wherein said first attempt is successful, a splash screen is first prompted to the device wherein advertisements stored within the memory are provided on the splash screen before the can connect to the internet; and wherein said first attempt to connect to the Wi-Fi network is unsuccessful, a Bluetooth message is provided to said device before provided for access to the Bluetooth network.

A method of providing advertisements to a Wi-Fi enabled device comprising a system having a processor and memory and a wireless antenna capable of providing a wireless Wi-Fi and/or Bluetooth networks over a given range; first transmitting a Wi-Fi network over said range, next connecting a Wi-Fi enabled device to said network, then providing a splash page to said Wi-Fi enabled device; and finally providing internet access free of charge to said Wi-Fi enabled device.

A method of providing advertisements to a Wi-Fi enabled device comprising a system having a processor and memory and a wireless antenna capable of providing a wireless Wi-Fi and a Bluetooth network over a given range; transmitting a Wi-Fi network over said range, attempting to connect to a device; attempting to send a Bluetooth connection message of to said same device; sending a Bluetooth connection message to said device; and providing a Bluetooth connection to said device.

A system for increasing advertising impressions to a billboard comprising a billboard and a wireless enabled network having a geofence, wherein said network comprises at least one antenna for transmitting and receiving Wi-Fi and/or Bluetooth signals, a server, and advertisements stored on computer readable memory; wherein a wireless device entering the geofence of said wireless enabled network is provided with an advertisement related to said billboard.

### BRIEF DESCRIPTION OF THE DRAWINGS

The following description, given with respect to the attached drawings, may be better understood with reference to the non-limiting examples of the drawings, wherein:

FIG. 1 depicts a block diagram of a network communication system for delivering content to mobile devices using long-range Wi-Fi/Bluetooth communication devices, in accordance with the disclosed embodiments.

FIG. 2 depicts a block diagram of a long-range Wi-Fi/Bluetooth communication device.

FIGS. 3A and 3B depict a perspective view and a side view, respectively, of a long-range, high-throughput Wi-Fi/Bluetooth communication device for outdoor use.

FIG. 4 is a block diagram of software modules for handling Wi-Fi and Bluetooth connections with mobile devices and content data transmission to the mobile devices.

FIG. 5 is a block diagram of a process for pairing a Bluetooth transmitter of the communication device with a mobile device.

FIG. 6 is a block diagram of a process for queuing and distributing handles for mobile devices which have been paired with a Bluetooth transmitter of the communication device.

FIG. 7 is a block diagram of a process for receiving a handle of a mobile device from a queue and using the handle to retrieve content from a database to be sent by the Bluetooth transmitter of the communication device to the mobile device.

FIG. 8 is a block diagram of a process for queuing and sending messages to a mobile device linked to a Bluetooth transmitter of the communication device.

FIG. 9 is a block diagram of a process for connecting a mobile device to a Wi-Fi transmitter of the communication device and performing an initial set up for connection of iOS/Mac mobile devices with the Bluetooth transmitter of the communication device.

FIG. 10 is a block diagram of a process for connecting and sending a message to an iOS/Mac mobile device to a Bluetooth transmitter of the communication device.

FIG. 11 is a block diagram of the process for connecting a mobile device to a Wi-Fi transmitter of the communication device or a Bluetooth transmitter of the communication device if a Wi-Fi connection cannot be formed.

FIGS. 12A, 12B, and 12C depict mobile devices displaying content received from the communication device.

### DETAILED DESCRIPTION OF PREFERRED EMBODIMENTS

All references cited herein are hereby incorporated by reference in their entirety.

As used herein, the term “about” is intended to encompass a range of values ±10% of the specified value(s). For example, the phrase “about 20” is intended to encompass ±10% of 20, i.e. from 18 to 22, inclusive.

The term “Wi-Fi” is used herein to refer to a wireless technology that allows an electronic device to participate in computer networking using 2.4 GHz and 5 GHz industrial, scientific and medical (ISM) radio bands. Wi-Fi is commonly defined as any wireless local area network (WLAN) product based on the Institute of Electrical and Electronics Engineers (IEEE) 802.11 standards. In the present application, as explained below, Wi-Fi communication devices are used for long-range communication with mobile devices.

The term “radio frequency” is used throughout the present application to refer to high frequency bands typically used for terrestrial communication, such as, for example Wi-Fi and Bluetooth communication, even though frequencies above 1 GHz are often referred to as “microwave frequencies” in this field.

Despite the intent of the original allocations, and because there are multiple allocations, in recent years the fastest-growing uses of these bands have been for short-range, low power communications systems. Cordless phones, Bluetooth devices, near field communication (NFC) devices, and wireless computer networks all use frequencies allocated to low power communications as well as ISM, although these low power emitters are not considered ISM.

The term “Bluetooth” is used herein to refer to a wireless technology for exchanging data using radio frequency waves in the ISM band from 2.4 to 2.485 GHz from fixed and mobile devices. In the present application, as explained below, Bluetooth communication devices are used for long-range communication with mobile devices.

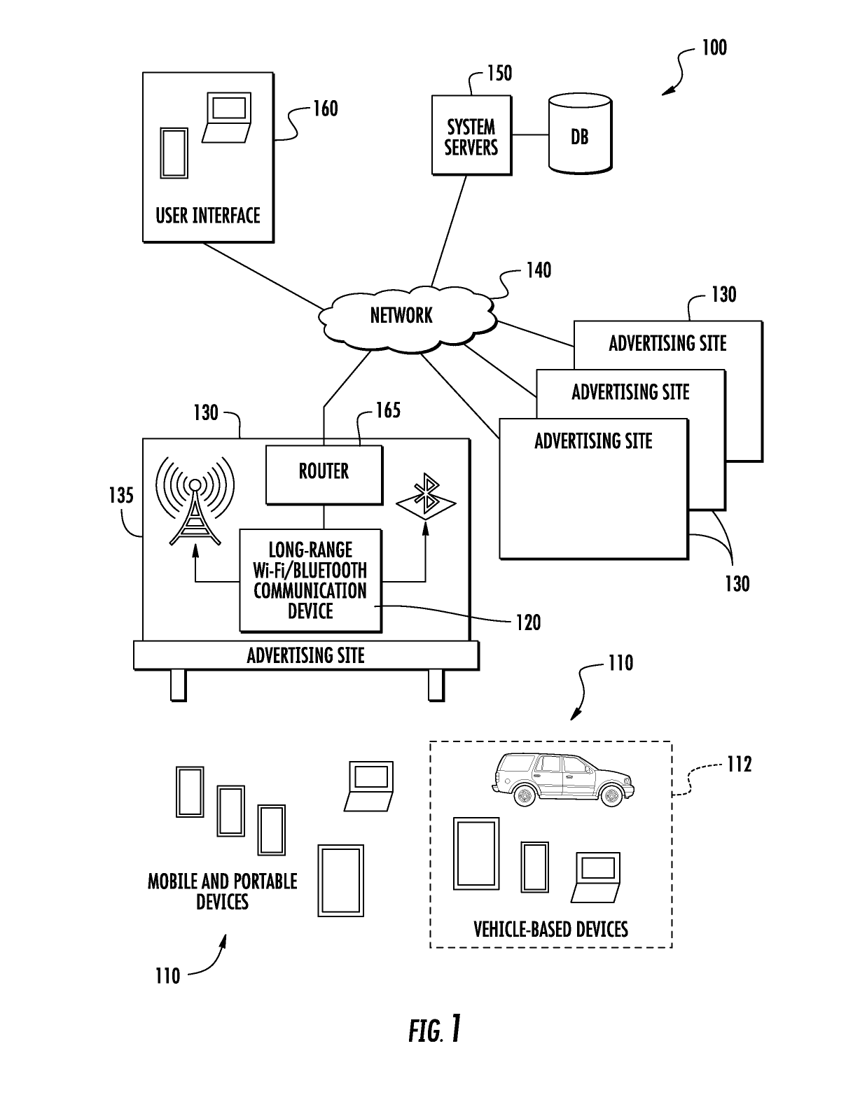

FIG. 1 depicts a block diagram of a network communication system 100 for delivering content, e.g., advertising data, to mobile devices 110 using long-range Wi-Fi/Bluetooth communication devices 120, in accordance with the disclosed embodiments. The network 100 includes long-range, high-throughput Wi-Fi/Bluetooth communication devices 120, described in further detail below, which provide long-range communication with a number of mobile devices 110 within their proximity. The communication devices 120 are capable of both Bluetooth and Wi-Fi communications and can perform such communications simultaneously with a number of mobile devices 110. As discussed below, each communication device 120 establishes communications with the mobile devices 110 within its proximity and then delivers content to the mobile devices 110. The mobile devices 110 can include, for example, mobile phones (e.g., smart phones), mobile computing devices (e.g., laptop computers and tablets), and vehicle-based Internet-enabled devices 112.

The network communication system includes a number of communication devices 120 installed in various locations, such as, for example, billboards, shopping malls, retail stores, subway and bus stops, and other advertising sites 130. In a typical embodiment, the communication device 120 will be installed in conjunction with a way for two to with a fixed advertisement, such as a billboard 135 or sign. The communication devices 120 are connected through a network 140, such as the Internet, to one or more content and control servers, i.e., system servers 150. The system servers 150 deliver advertising data to the communication devices 120 which, in turn, is delivered to the mobile devices 110 within proximity of each of the communication devices 120.

These servers may also perform various administrative and control functions vis-à-vis the communication devices 120.

The system servers 150 provide a user interface 160 through a network 140, such as the Internet, which allow users to upload and manipulate content to be distributed through the network communication system 100. The user can upload and store content and set various parameters which controlled the distribution of the content. For example, the parameters may control the scheduling of the distribution such that the content is delivered at a particular time of day or in particular geographic regions, e.g., by selecting a particular subset of the advertising sites 130. The user may also select a sequence of content elements to be displayed in a particular order. These control functions may be performed by the administrators of the network communication system and also by advertising clients, who may be limited to a particular subset of the functionality. The user interface 160 may be accessed by various types of Internet-enabled computing devices, such as personal computers, tablets, and laptops.

The user interface 160 also provides system monitoring functions which allow the user to study and extract data relating to the performance of the network communication system 100. For example, the monitoring functions may present to the user an indication of the number of mobile devices 110 presently in communication with each communication device 120 in the system. The monitoring functions may also provide historical data regarding the distribution of the content, e.g., an indication of how many mobile devices 110 received each particular piece of content over a particular time period. As a further example, the monitoring functions may also provide an indication of the number of mobile devices 110 which have interacted with each particular piece of content over a particular time period. In addition to the monitoring functions, the user interface 160 may also provide various administrative functions relating to billing, such as the ability to calculate advertising fees based on the various types of statistics mentioned above.

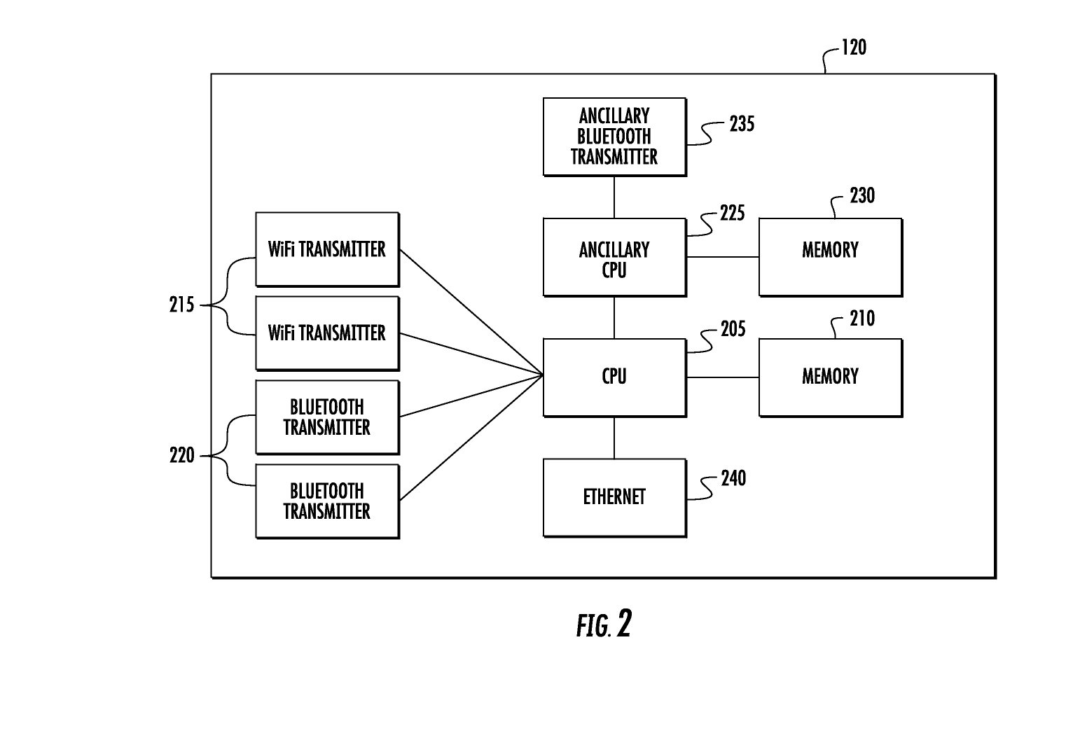

FIG. 2 shows a block diagram of the long-range, high-throughput Wi-Fi/Bluetooth communication device 120. The device is controlled by a microprocessor, i.e., a central processing unit (CPU) 205, which has an associated memory 210. The CPU 205 is connected to one or more Wi-Fi transmitters 215 and one or more Bluetooth transmitters 220. The term “transmitter” is being used herein to generically describe devices which transmit and receive communication signals. The transmitters also provide modulation and demodulation of the Wi-Fi and Bluetooth data so that it can be communicated to the CPU.

The use of multiple transmitters of each type, Wi-Fi 215 and Bluetooth 220, increases the throughput of the communication device 120, i.e., increases the number of mobile devices 110 with which the communication device 120 can connect at one time. This is especially important for installations in crowded locations, such as urban environments, where a large number of mobile devices 110 may be present at any given time. The multiple transmitters could also be divided among the antennas (e.g., each transmitter being connected to a dedicated antenna) as a means of dividing the load. There may also be an ancillary CPU 225 (and associated memory 230), connected to the CPU 205, e.g., via a universal serial bus connection (USB), for redundancy and/or load sharing. The ancillary CPU 225 may be connected to one or more ancillary transmitters, e.g., an ancillary Bluetooth transmitter 235, to further increase the throughput of the device. The ancillary Bluetooth transmitter 235 also may have special characteristics for particular installations, e.g., an especially high sensitivity long-range reception of Bluetooth signals.

The CPU 205 is also connected to a network interface 240, e.g., an ethernet interface which provides access to the Internet. For example, the communication device 120 may be connected through the ethernet interface 240 to an Internet-connected switch or router 165 (see FIG. 1), if there is one installed at the advertising site 130, or a cellular modem. Alternatively, the device may have a built-in router and/or modem. The network interface 240 allows the communication device 120 to communicate with the system servers 150, as described above in connection with FIG. 1, to receive content to be delivered to the mobile devices 110 as well as for command and control purposes.

The communication device 120 may be configured to transmit Wi-Fi and Bluetooth signals of to a maximum range of about 0.5 miles (i.e., about 800 m). The Wi-Fi and Bluetooth transmitters have an output power of 500 mW (used with a transmit antenna having a gain of 9 dB) or 1 W (used with an antenna having a gain of 6 dB), which is the current Federal Communication Commission (FCC) limit for unlicensed broadcast in the 2.4 GHz range. This is a significantly longer range and higher power than that of the most powerful defined class of Bluetooth devices, Class 1, which have a maximum range of 100 m and an output power of 100 mW. The maximum range of the communication device 120 may be defined as the maximum distance at which a typical mobile device, e.g., cell phone or laptop computer, can effectively receive and process the transmitted Wi-Fi and Bluetooth signals. This range may be determined by the “link budget” parameters of the equipment, such as, for example, transmit power, antenna gain, and receiver sensitivity, and the environment through which the signals are transmitted. In alternative embodiments, the maximum range may be about 0.25 miles (i.e., about 400 m).

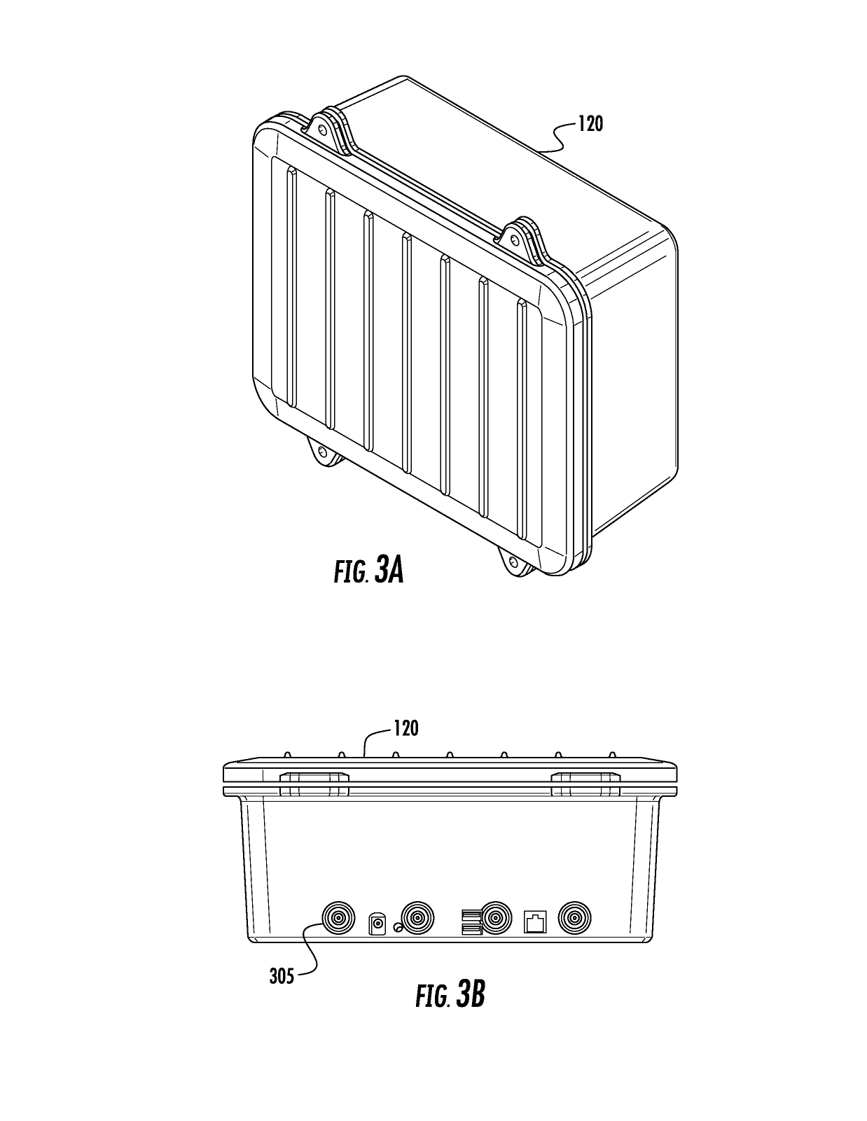

FIGS. 3A and 3B depict a perspective view and a side view, respectively, of a long-range, high-throughput Wi-Fi/Bluetooth communication device 120 for outdoor use. This particular embodiment is designed for outdoor use, e.g., for mounting on a billboard. The electronic hardware of the communication device 120 is installed within a weather-resistant housing, e.g. a plastic or metal housing, which has tabs with holes extending from the base of the housing and the lid of the housing to allow the lid to be securely attached to the base. The housing is designed to be installed in the infrastructure of a sign or billboard or other type of advertising installation. The side of the housing includes connector ports 305 for the various electrical connections, such as, for example the power connection, external wireless router connection, and the radio frequency inputs/outputs for the one or more antennas.

The antenna configuration at a particular advertising installation site will depend on the nature of the site and the surrounding environment. A typical site will have more than one antenna, the antennas having reciprocal transmission and reception capability. Configurations of multiple antennas can be used for multiple-in multiple-out (MIMO) spatial multiplexing or antenna diversity depending on how the software is configured.

As mentioned above, the communication device 120 provides both Bluetooth and Wi-Fi communication capability. A typical Wi-Fi setup utilizes a router and an antenna to create access points where a mobile device or any other device capable of connecting to a Wi-Fi network can send and receive data wirelessly. The Wi-Fi setup may include a personal computer or server which is connected to the Internet, e.g., by a router, and which incorporates a Wi-Fi transmitter/receiver and an antenna. Such setups can be password protected (i.e., a password is required to access the Wi-Fi), or “open,” in which case no password is required. There are significant costs in maintaining Wi-Fi networks for public consumption. Costs typically include the administrative costs associated with maintaining user names, passwords, data utilized, income, and other ordinary items that must be databased and safely maintained. Thus, users of these public Wi-Fi networks (e.g., coffee shops, hotels, restaurants, airports, and other public locations) are frequently asked to pay for their use.

Nearly all modern laptop computers have Wi-Fi components installed, so laptop users are able to access these fee-based public systems for Wi-Fi access. In addition, many smartphones, tablets, and other types of mobile devices now incorporate Wi-Fi chips so that internet access may be achieved on these devices through Wi-Fi or network-enabled wireless, such as the 3G and 4G systems.

A typical Wi-Fi network access by a user in a public domain begins with a user activating a Wi-Fi network search on their device (or the device may be set to automatically search for Wi-Fi networks). Authentication begins with the user device sending an authentication frame to the Wi-Fi access point containing its identity. With an open system authentication, the user device sends only a single authentication frame (which may be considered to be an “access request”), and the access point responds with an authentication frame of its own indicating acceptance or rejection. With shared key authentication, after the user device sends its initial authentication request it will receive an authentication frame from the access point containing challenge text. The user device sends an authentication frame containing the encrypted version of the challenge text to the access point. The access point ensures the text was encrypted with the correct key by decrypting it with its own key. The result of this process determines the authentication status of the user device.

The Wi-Fi networks are typically password protected and require a password, and also usually a payment, to unlock the Wi-Fi network. For example, at a local coffee shop, a user opens a laptop with Wi-Fi enabled and searches for a Wi-Fi network. Upon connecting to a network, the user is presented with a web page requiring the user to agree to terms of use and/or other agreements before using the network. The user may also be presented with a “splash page” which asks the user to order products, read news, review an advertisement, or satisfy some other requirement before Wi-Fi access is granted.

The procedure for establishing a Bluetooth connection is somewhat different than the procedure for accessing a Wi-Fi network described above. When a device having Bluetooth capability comes within range of a Bluetooth transmitter, the device attempts to “pair,” i.e., connect, with the transmitter. A short message is transmitted to the Bluetooth device by the transmitter. The message may be, for example, a random string of characters. The message is entered by the user into the Bluetooth-enabled device (or clicked on by the user) to pair the device with the transmitter. Alternatively, the pairing message may be displayed by an advertising site 130, e.g., displayed on an electronic billboard screen, for entry into the user's device.

In particular embodiments, rather than sending a pairing code in the form of a random sequence of characters to establish a Bluetooth connection, the pairing request message may contain a simplified preview of an advertisement to be delivered, e.g., “Free Coupon!” or “Get 20% off now!”, or “Verizon Wireless would like to send to you their latest exciting offer: Will you accept file//Exciting offer.png?”. If the mobile device user clicks on the pairing message, or enters the pairing message into the device, the mobile device will be paired with the transmitter and the full message will be delivered.

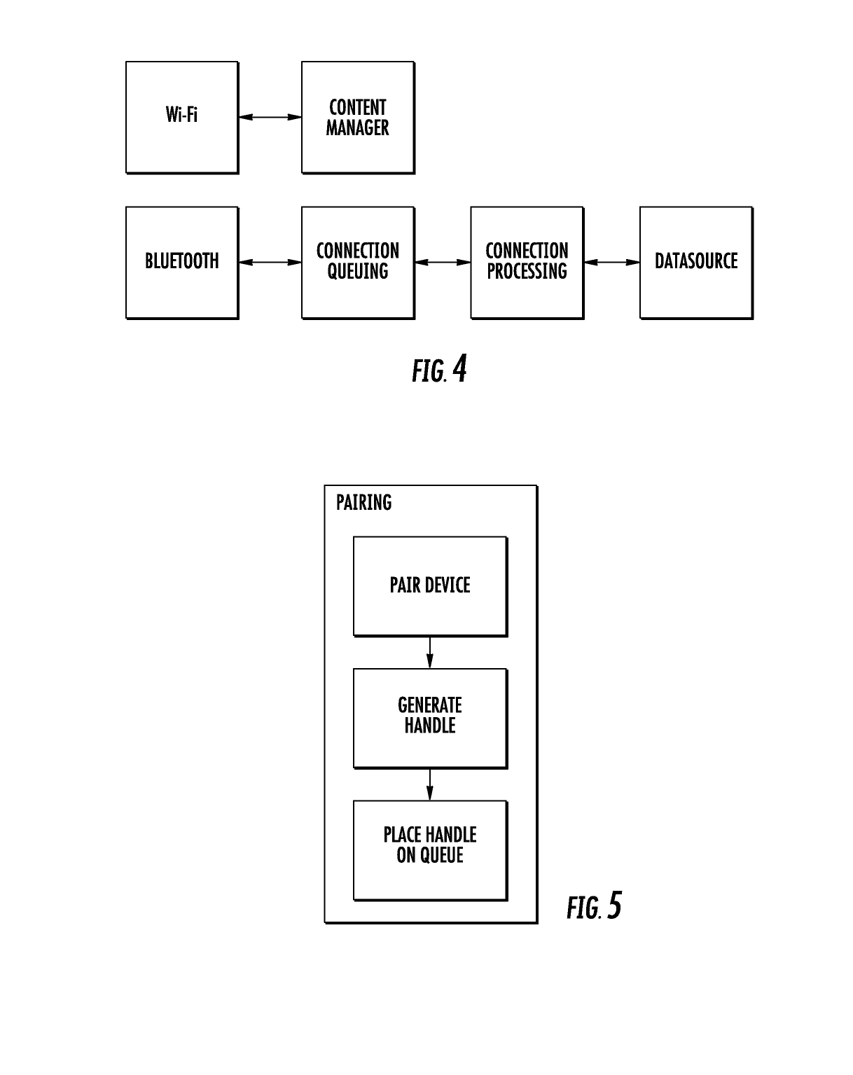

As shown in FIG. 4, the communication device may be considered to have a number of software modules for handling Wi-Fi and Bluetooth connections with mobile devices and content data transmission to the mobile devices, each of the modules having a particular set of functions. The software controls the method by which the communication device establishes connections with user devices. A transformation process is applied to the connection and device information, and the transformed data is then cross referenced against a database of historic connection information. Following processing of a connection, content, e.g., an advertisement, is sent to the device. Advertisement content may be managed by a third-party application.

The system can be considered to have three major areas: connection management, connection transformation (i.e., processing), and content provisioning. As noted above, the disclosed embodiments use two network connection protocols: Wi-Fi and Bluetooth. Connections are established with devices and then passed to the connection handling part of the system. The connection is used at the end of the processing cycle to send out content to the device.

The content manager component of the Wi-Fi branch represents a broad module that both handles incoming Wi-Fi connections and then returns held content to a connected device. Connection handling in the Bluetooth branch can be broken down into queuing and processing. The queuing portion of the solution is concerned with taking the raw network interface connection, producing a general use object that encapsulates the connection and then placing the object onto a queue to await handling. The processing portion is concerned with taking a generated object from the connection queue and transforming it so that it can be used against the database and enable content selection.

The data handling portion is may be considered to encompass the database abstraction layer and the database itself. The database may be, for example, a simple schema that records devices and the content, e.g., advertisements, that have been sent to each device. It may contain functionality allowing for processing of provisioned data and advertisement selection. The database abstraction allows for insertion of processed connection objects into the database via transactions.

The overall design of the system can be broadly split into two distinct branches, one for each network interface the solution will use. In the Wi-Fi branch most of the functionality is provided by content management software that serves content to Wi-Fi connected devices. The design of the Bluetooth branch, on the other hand, essentially amounts to a pipeline. A raw connection is taken from the Bluetooth network interface, abstracted into a record object, processed, and then a content resultant is returned. Among other notable features, the system is capable of accepting multiple connections at any time and is also capable of distributing content to multiple devices due to features which allow for a high throughput of connections. A scripting language, e.g., Python, may be used to construct all needed programmatic artefacts in the system. Python is well-suited due to its brevity, wide application fields and extensive number of available libraries. These attributes reduce, and in some case eliminate, the need for low level programming. Other programming languages may also be used.

The “content manager” is a software module that can send rich content across the wireless interfaces to user devices. The software has the ability to store and maintain content through its internal storage mechanisms and then serve that content to connected devices when applicable. A raw interface connection may be placed upon an in-memory queue which is provided by a software library. The queue may be hardened for concurrency to allow for multi-threads which are capable of adding to and taking from the queue.

As a practical matter, connections are not expected to live for long periods on the queue, as their processing is not expected to take prolonged periods, so a connections time for the queue should be minimal. There are a large amount of threads waiting to take connections and process them from the queue to avoid having the queue become a bottleneck. For the system to handle multiple connected devices, it is considered best to avoid a single-threaded solution, which could lag in its ability to serve content. Connections are taken from the connection queue as they arrive, i.e., a connection will be distributed to a waiting thread for processing. Employing a threaded nature in the system allows for throughput to remain high and allows the system to serve multiple devices at any one time. In the case where the queue is empty the solution remains in a waiting state, monitoring the connection queue for a new connection to process. As some of the system activity will be backed by a database, with multiple threads potentially accessing or potentially inserting data, it is necessary to enable transactional behavior for database access. Transactional behavior ensures that integrity of the data is maintained, protects against unpredictable behavior, despite multiple threads working with it, and protects against unwanted behavior due to data.

As noted above, the system is configured to target devices that have either Wi-Fi or Bluetooth connectivity. When a device come within range and has either interface open, the system will attempt to negotiate a connection. The Wi-Fi branch of the system is based on content management software, such as, for example, Plone. Plone is a free and open source content management system built on top of the Zope application server, which is a free and open-source, object-oriented web application server written in the Python programming language. Plone provides a web framework which allows customizing and deploying of dynamic web content. As part of the “hotspot,” i.e., Wi-Fi, infrastructure, Plone allows quick changes to existing display campaigns. It is highly extensible and has its own web interface that can be customized and used to design and update webpages. It is highly secure and currently utilized broadly by government and private entities.

As noted above with respect to FIG. 4, the Bluetooth branch of the system uses various software modules to facilitate the serving of content, e.g., advertisements, to personal devices via Bluetooth. FIG. 5, in particular, depicts a process for pairing a Bluetooth transmitter of the communication device with a mobile device. The framework for using the pairing functionality, OpenProximity, allows content to be delivered directly to a user's Bluetooth device. Leveraging this framework, the code will capture the unique device ID, e.g., a media access control address (MAC) address, and pass it along to the connection queuing system to create a “handle”.

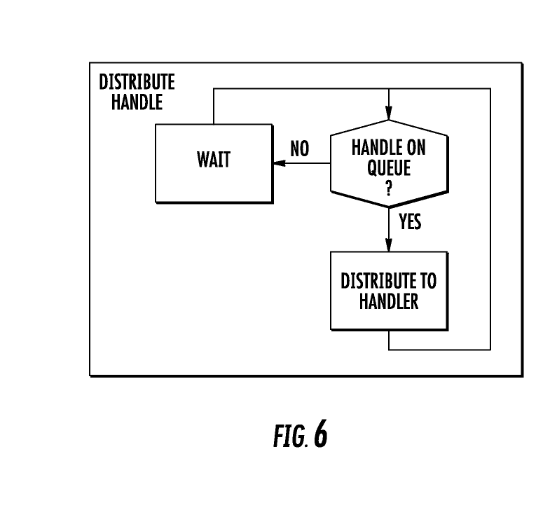

FIG. 6 depicts a process for queuing and distributing handles for mobile devices which have been paired with a Bluetooth transmitter of the communication device. After the queuing system has handed the device ID, the connection component waits for the message response from the handler. The connection remains available until either the user has left the proximity or the message is available to be delivered. The turnaround time for a message is negligible, so the connection will be maintained and triggered on pairing with the device. Thus, following establishment, Bluetooth connections are placed in a queue to awaiting processing. Python has built-in features for constructs such as queues, i.e., the application uses a specific implementation from Python's concurrent library. The queue artefact from the concurrent library places guards around many of the objects methods and variables, preventing common concurrency related issues from arising.

The connection handler is the main Python application of the system. It has a looping mechanism that polls the head of the queue. When the queue is empty, the application waits for the queue to be populated. When a connection is taken from the queue, it is passed to a separate thread from the main application and processed independently. A thread pool from the Python concurrent library is used to distribute connections to worker threads. Worker threads are Python threads that have been passed a common handler method that they run concurrently. The handler method takes the connection and transforms it for provisioning to the database.

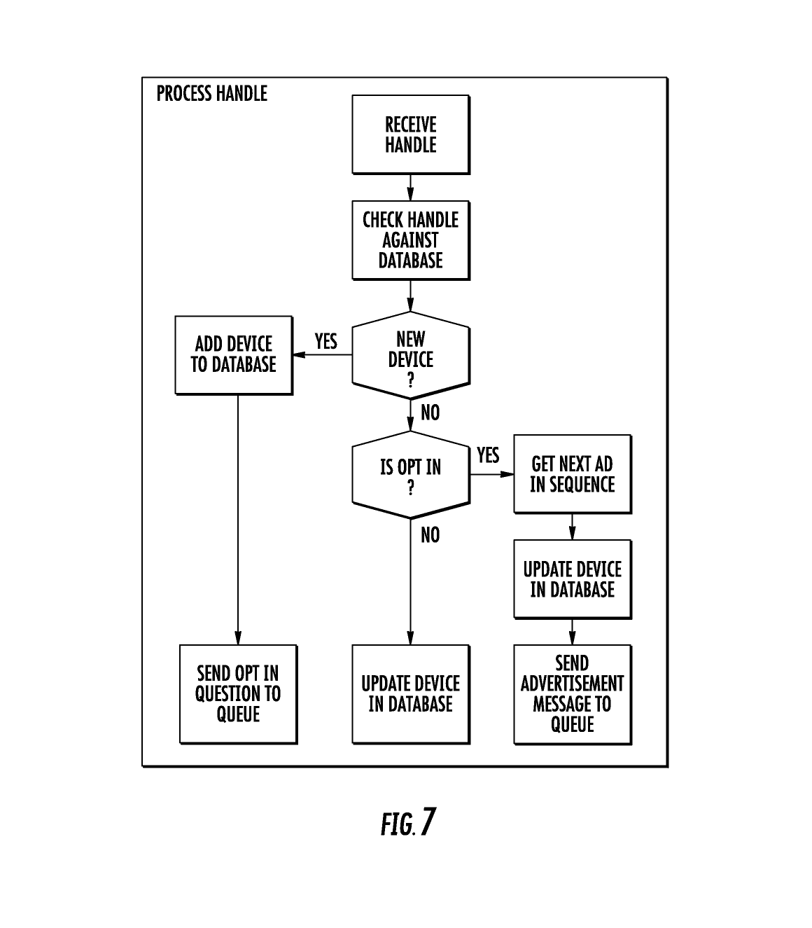

FIG. 7 is a block diagram of a process for receiving a handle of a mobile device from a queue and using the handle to retrieve content from a database to be sent by the Bluetooth transmitter of the communication device to the mobile device. The handle taken from the queue is received by the handling process and checked against the database. If the device is a new device, i.e., a device which has never before connected with the system, then the device is added to the database. An “opt-in” question is then sent to the queue. If, on the other hand, the device is not a new device, then a determination is made as to whether the device is opt-in, i.e., whether the device has been set up to accept Bluetooth transmitted advertising. If the device is opt-in, then the next advertisement in the sequence is retrieved, and the records for the device in the database are updated accordingly.

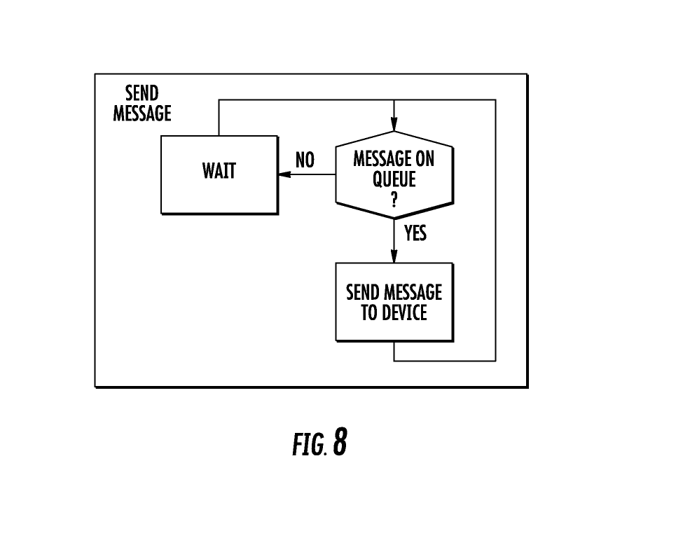

FIG. 8 is a block diagram of a process for queuing and sending messages to a mobile device linked to a Bluetooth transmitter of the communication device. After the processing described above with respect to FIG. 7, the advertisement message is sent to the queue to be transmitted via the Bluetooth link to the user's device. The message remains in the queue until there is an opportunity to send it to the device.

Database interactions are facilitated through the use of a Python library of the database application MySQL (which is a widely used open-source relational database management system). There is a single connection to the database that is abstracted in Python by a datasource object, to which the worker threads have access. Multiple threads make use of this Datasource, so it is necessary avoid concurrency issues. The datasource makes use of Python's transactional capabilities, which are used by the MySQL library. This eliminates the need to programmatically define transactions, thereby simplifying implementation and avoiding the need to explicitly define transaction boundaries in the code. The database schema may not be of such significant scale that it becomes necessary to map the database to record objects. Therefore, the database abstraction layer employs predefined queries that can be customized based on the processing of a connection record. MySQL was chosen as the database to back the Bluetooth branch of the system, because it is a fully-featured and robust relational database. It is used to track unique user IDs to ensure that users receive the correct messages.

The design structure allows for independence between the components (Bluetooth and Wi-Fi) and for extensibility in alternative embodiments. Furthermore, by using a system for message queueing between the Bluetooth device and the database that handles generic datastructures, it is possible to refactor this configuration for extensions and to incorporate the process into the Wi-Fi branch to allow more effective targeting and advertisement in various alternative embodiments. The use of MySQL facilitates the process of migrating to a centralized database which will allow greater flexibility in alternative embodiments. As discussed above, the Wi-Fi branch is designed to take advantage of the powerful CRM abilities of Plone and allows for easy refresh of content. The Python messaging system used for the Bluetooth branch of the system can be used, in alternative embodiments, for the Wi-Fi branch.

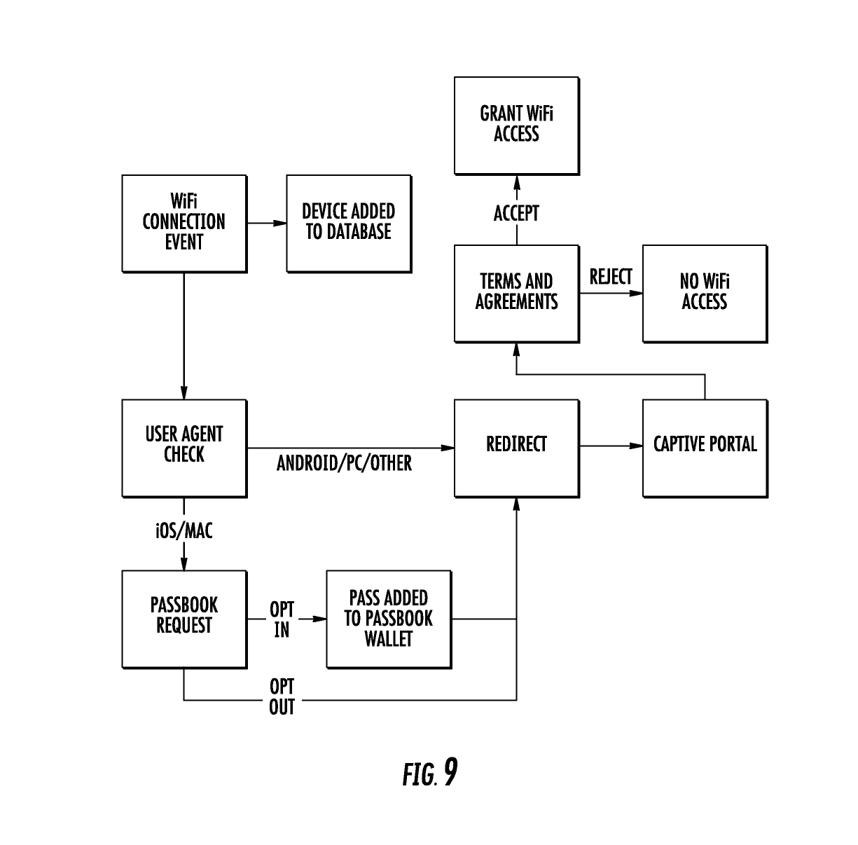

FIG. 9 depicts a process for connecting a mobile device to a Wi-Fi transmitter of the communication device and performing an initial set up for connection of iOS/Mac mobile devices with the Bluetooth transmitter of the communication device. In particular embodiments, this method is provided for establishing Bluetooth communication with devices running the mobile operating system “iOS” or the personal computer operating system “Mac OS” (operating systems produced by Apple Computer, Cupertino, Calif.). In this method, there has been a Wi-Fi connection established with the device at a previous time by the network communication system and identifying information for the device has been added to a database. During the Wi-Fi connection event, the “user agent” of the device is checked to determine the operating system in use on the device. If the user agent is determined to be running the Android Operating system (provided by Google, Mountain View, Calif.) or some other type of operating system, then the method proceeds to a redirect step.

If the operating system is iOS or Mac OS, then a request is made to access the “Passbook” provided by the operating system for storing credentials such as boarding passes identification cards, etc. If the device is set for “opt-in,” i.e., the device is set up to allow the reception of Bluetooth advertisements, then a pass is added to the Passbook Wallet the device. Storing the pass in the wallet will facilitate later Bluetooth communication, as described below. If the device is not set for opt in, i.e., the device is set for “opt-out,” then the Passbook storage step is bypassed and the method proceeds with the redirect step.

The redirect step causes a web browser of the user's mobile device to be redirected to a particular website at a domain which is referred to as the “captive portal”. The captive portal presents webpages relating to terms and agreements which the user is prompted to accept or reject. If the terms and agreements are accepted then the captive portal provides Wi-Fi access to the user. If the terms and agreements are not accepted, then Wi-Fi access is not granted.

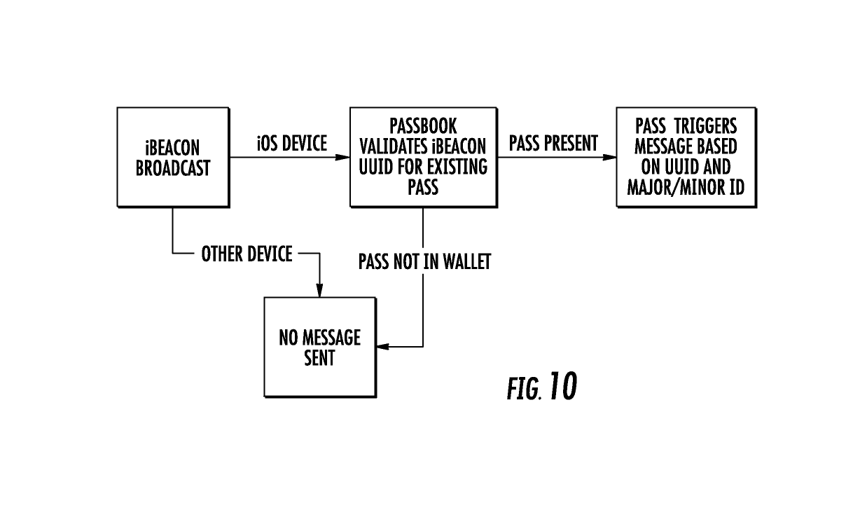

FIG. 10 depicts a process for connecting and sending a message to an iOS/Mac mobile device to a Bluetooth transmitter of the communication device. Once the Wi-Fi connection process described above has been completed on one occasion, assuming a pass was successfully stored in the Passbook, then it will be possible to provide Bluetooth communication with a device running iOS or Mac OS. To provide this communication, and “iBeacon” broadcast is made and if an iOS devices in the vicinity, the Passbook of that device will be checked for a pass corresponding to the iBeacon request. If a device in the vicinity is not an iOS device, then no Bluetooth message is sent. Likewise, if the Passbook of the iOS device does not have a corresponding pass stored herein, then no Bluetooth message is sent to the device. If, on the other hand, the Passbook of the iOS device contains a corresponding pass, then a Bluetooth communication may be made based on the universally unique identification (UUID) and major/minor ID.

Referring again to the Wi-Fi capabilities of the communication device, a Wi-Fi transmitter transmits in a particular range which may be defined in terms of a geofence. As used herein, the term “geofence” means a network-enabled zone having Wi-Fi and/or Bluetooth access, the boundaries of the zone being defined by the maximum range at which Wi-Fi or Bluetooth signals can be successfully processed by the user device. A geofence may also be defined by using location information of a user device to determine whether the location of the user device relative to a defined reference location meets defined parameters.

Accordingly, the space within the geofence is within an acceptable distance from the transmitter to receive and send data over the Wi-Fi network. In particular embodiments, a user having a Wi-Fi equipped device who is within the geofence, connects to the free Wi-Fi network and a splash screen is sent to the user providing content, e.g., advertisements, before connection to the internet is completed. A second user, in this particular example, would not able to connect to the internet if the second user were not within the geofence, regardless of whether the second user's device is searching for a Wi-Fi network. Movement of the second user to a point within the geofence would be necessary to access the Wi-Fi network.

As a further example, there may be two transmitters—a Wi-Fi transmitter and a Bluetooth transmitter. A geofence defines the boundary of the network for both the Wi-Fi and Bluetooth. A user having a Wi-Fi enabled device is within the geofence, and the user's device searches for free or Wi-Fi that is not password protected. A splash screen is first presented to the device before connection to the internet. A second user, in this particular example, has a device that does not have settings to search for free Wi-Fi automatically, or the device does not have a Wi-Fi connection capability. Instead, the device has Bluetooth capability. A first attempt to contact the device via Wi-Fi is unsuccessful, because there is not Wi-Fi connectivity with the device. A second attempt to contact the device via Bluetooth sends a pairing message to the device, which allows successful pairing with the transmitter, and a full message is delivered to the device.

In a further example, three billboards are located in proximity to each other so that their respective geofences overlap. Each of the billboards has an antenna which transmits and receives to create a network within the geofence of the billboard. A user situated within two of the geofences would be capable of receiving free Wi-Fi from two different signals to the device. By comparison, if a user is not within any of the geofences, then that user's device, regardless of its capabilities, would not be able to access any of the networks provided.

FIG. 11 depicts a process for connecting a mobile device to a Wi-Fi transmitter of the communication device or a Bluetooth transmitter of the communication device if a Wi-Fi connection cannot be formed, in an alternative embodiment. A signal is provided wherein a signal is provided from an antenna to a device. If the device has Wi-Fi enabled and, then whether the device is searching for free Wi-Fi determines the path. If the device is searching for free Wi-Fi and, then a splash screen will be shown to the user and Wi-Fi access will be provided subsequent to the splash screen being identified. If the device is Wi-Fi enabled but is not searching for free Wi-Fi, the question will revert the Bluetooth decision tree below. If there is no Wi-Fi capability on the device, then a determination is made as to whether the device has Bluetooth capability. If there is no Bluetooth capability, then no connectivity can be achieved with the device. If there is Bluetooth then a message will be sent.

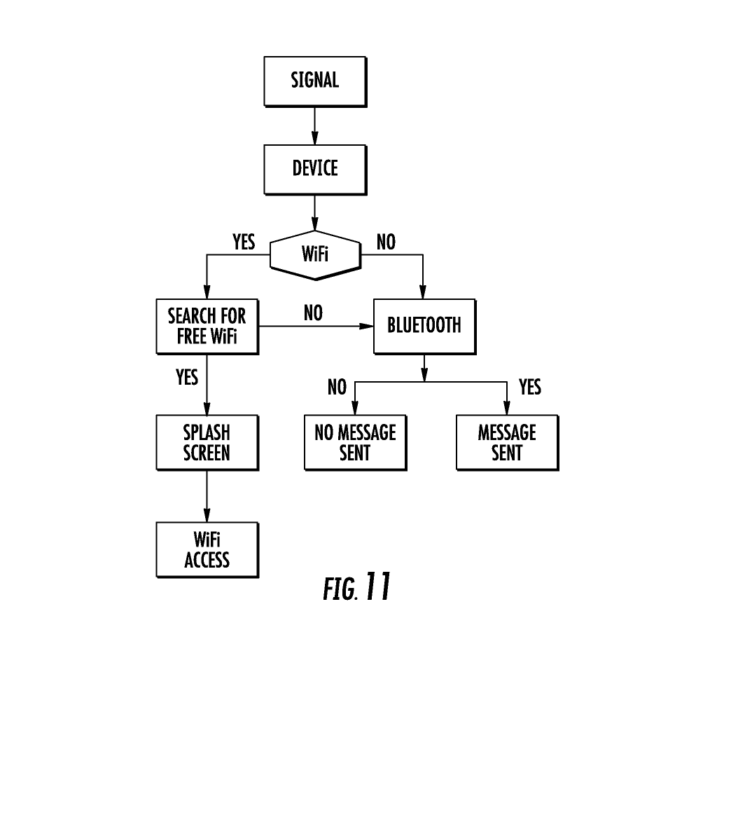

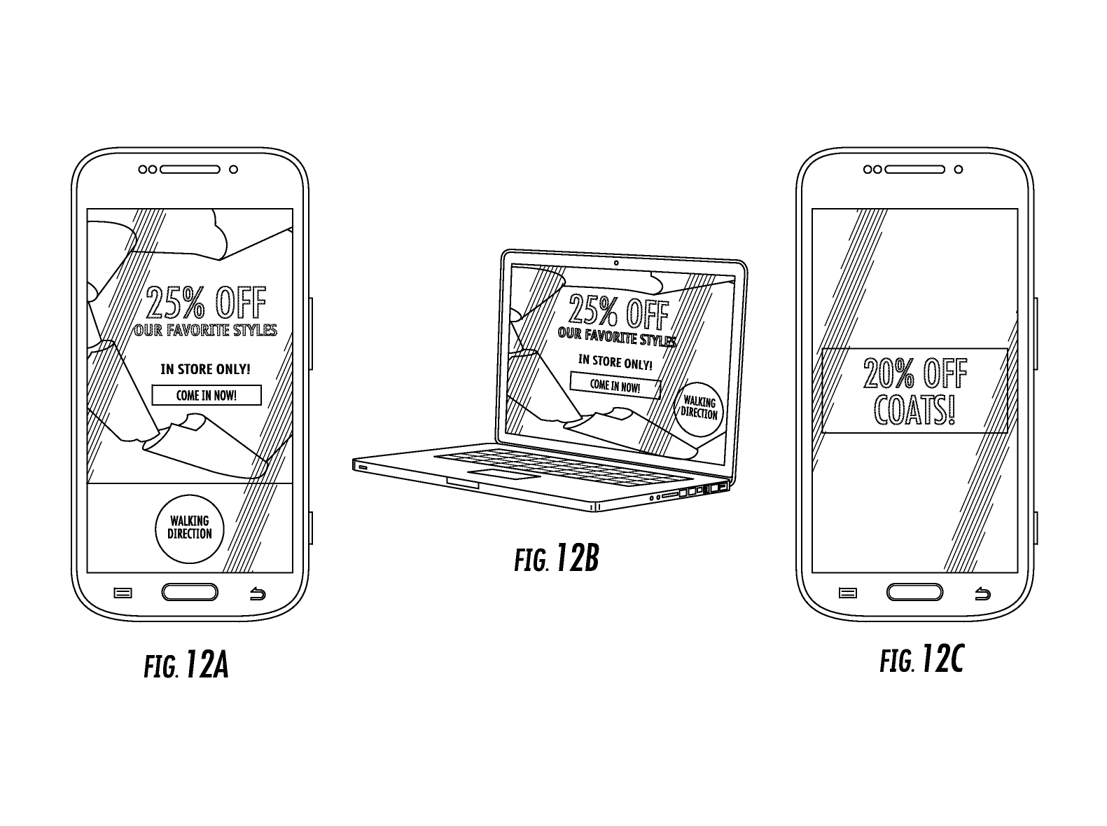

FIGS. 12A, 12B, and 12C depict mobile devices displaying content received from the communication device. FIGS. 12A and 12B, for example, depict a mobile phone and a laptop, respectively, which display content received via a Wi-Fi connection with the long-range Wi-Fi/Bluetooth communication device. The content may include a splash screen which provides advertisements and which may include images, text, uniform resource locator (URL) links, other enabled or clickable links, clickable images, videos, and other forms of printed media that are capable of being presented on a mobile computer device. The splash screen may have a duration of about 30 seconds. However, other embodiments include splash screens of a duration of less than 60 seconds, 45 seconds, 30 seconds, 20 seconds, 10 seconds, 5 seconds, 2 seconds, and 1 seconds, as well as times in between. In some circumstances, durations of longer than 60 seconds, such as 120 seconds may be advantageous. After the splash screen is viewed, a browser page may be presented and free access to the internet over the Wi-Fi connection may be provided.

FIG. 12C shows a mobile phone displaying a Bluetooth pairing message, i.e., a character string, which is transmitted to the mobile device and is clicked on by the user to receive further content, which may be a page similar to that depicted in FIG. 12A. In one embodiment, the message transmitted to the Bluetooth enabled device is actually an advertisement per se. In other words, the pairing message is the actual advertisement. For example, where a Bluetooth transmitter provides a signal to a defined area around a particular store, the message could provide a coupon or some other advertisement to Bluetooth enabled devices thus providing the advertisement, e.g., “20% OFF COATS!”. This allows the advertisement to reach the consumer without the need to first pair the Bluetooth device to the Bluetooth transmitter, install an application or program on the Bluetooth device, or to otherwise have signed up for a program to push advertisements to the device. Instead, the user may receive advertisements based solely on their proximity to a particular Bluetooth transmitter.

In embodiments disclosed herein, the conventional methods of presenting terms of use agreement pages, requiring payment for use of Wi-Fi, and enforcing password protections are done away with. Instead, the network communication system provides a Wi-Fi network that is free from passwords. It is a free Wi-Fi network, and any user that passes within the free Wi-Fi network and has enabled settings to connect to a free Wi-Fi network will be presented with a splash screen containing advertisements. This bypasses the splash screen that requires the use of a password, or a membership, of purchasing of a one-time use, or purchase of a monthly, or multiple use access, or some other pre-paid access or coupon. Instead, the user will get a splash screen having one or more advertisements and thereafter is provided with internet access through the Wi-Fi network.

In particular embodiments, if the user's device is not enabled for access to Wi-Fi networks, the system may attempt to establish a Bluetooth connection with the device. That is, an embodiment of the system comprises a first Wi-Fi network enabled to provide free Wi-Fi and a splash screen to users having Wi-Fi enabled. Where users do not have Wi-Fi enabled, a secondary contact system is the Bluetooth system that provides a message to a Bluetooth enabled device. Thus, the system has a first and a second transmission system and provides two ways to access a device that passes through a particular zone. The Wi-Fi and Bluetooth messages are transmitted utilizing the same antenna and are contained within a single device, which enables a layered capability from Wi-Fi to Bluetooth when a phone comes within the broadcast range.

Advertisements that are presented either on a splash screen or via the Bluetooth message can be in the form of an actual advertisement, a coupon, a message, or some other form of advertising. Similarly, the message may provide a link to a store, to a coupon, to an app or application. This allows for advertising entities to utilize what they believe to be most effective for their target audiences.

In a particular embodiment, a system comprises a billboard having one or more antenna enabling a Wi-Fi and a Bluetooth connection, wherein said one or more provide a geofence where within said geofence, a network is enabled. When a user having a Wi-Fi and or Bluetooth enabled device enters the geofence, and where the user's device is enabled to search for free Wi-Fi networks or is enabled for Bluetooth connectivity, the network first seeks to present a splash page through the Wi-Fi network to the user's enabled device. This provides an advertisement on the splash page while providing free Wi-Fi. If the user's device is not enabled to seek free Wi-Fi, the Bluetooth network then seeks to send a message containing an advertisement to the user's device.

This is particularly relevant in some embodiments to providing additional impressions to a billboard as a splash screen message may be directly related to the billboard, such as providing a coupon, a link to the nearest store, or other advertisement that then is maintained on a device despite passing the billboard. This enables additional advertising impressions for the billboard.

In a particular embodiment, a network may overlap with one or more other networks, each providing free Wi-Fi or Bluetooth connectivity, and allowing a user to move within the range while continuing their internet access. For example, in a mall, various geofences may be present in the mall, but each overlapping. In at least one embodiment, by moving into different geofences, a new splash screen is presented. This captures the intention to provide real-time content, e.g., advertisements, based on the location of an individual. In a mall, there are typically anchor tenants at end ends, and smaller tenants in between. A first geofence may be present at one end of the mall with one anchor tenant. A splash screen presented there may provide an advertisement related to that anchor tenant. Moving away from that anchor tenant, a new geofence may be present for a grouping of smaller tenants. A new splash screen may appear and provide new advertisements regarding those tenants. Finally, moving to the end of the mall, to another anchor tenant, a new splash screen may appear to provide advertisements related to that tenant.

Accordingly, each of the various geofences may comprise a different splash screen. The particular advertisements may be stored by a server or other memory device situated within the particular geofence. This provides that a single server or computer or memory device can be connected to an antenna and allows for modification of the advertisements in that location.

In other embodiments, a centralized server may provide advertisements for many different locations and wherein the same advertisements may be projected to all locations or specific advertisements may be presented to each of the various geofence locations.

It is envisioned that in a setting such as a mall, there may be dozens or more individual geofences wherein a user device could receive different messages or advertisements within each of these locations.

Similarly, within a single location, there may exist more than one advertisement at a time. The advertisements may rotate based on time or simply on a random or rotating basis.

It is envisioned that a device being within a single geofence may receive more than one splash screen. That is a first connection to a Wi-Fi network provides a first splash screen. A few minutes later, a second splash screen will appear, providing a different advertisement. Again, a few minutes later a third splash screen will appear. The splash screens will continue to rotate through all advertisements, and will ultimately return to the first splash screen when all permeations are expended. Accordingly, free Wi-Fi or Bluetooth Access is provided for a given duration before a new splash screen is displayed. The duration of Access is between about 30 seconds and about 5 minutes. In other embodiments, the duration of Access before a new splash screen appears is about 1 min, 5 min, 10 min, 15 min, 20 min, 30 min, 45 min and one hour.

An embodiment comprises a feature that each splash screen is made up of more than one advertisement and that the advertisements may independently rotate, thus providing a greater number of possible splash screens because of the flexibility of the more than one advertisement per splash screen. Even so, ultimately, some splash screens will be duplicative upon enough impressions of the splash screen.

A user seeing said splash screen may see an advertisement that interests them an actionable feature is provided to lock that advertisement, in the case that it is a coupon for an item the user desires, for example.

Furthermore, a user seeing the splash screen may also not see any advertisements of interest and may click to see further advertisements. This allows an interested user to browse through more than one advertisement in seeking to see what advertisements or specials may be of interest to the user.

In some cases, the splash screen may provide one time only deals, or special deals on a rotating basis. This provides that the splash screen may function as a lottery system, wherein a set number of different splash screens exist on a given day and wherein one or more than one of these splash screens are “winning tickets,” that is, provide a free item, a larger discount, or some other bonus. For example, there may exist 1000 different iterations of a splash screen within a given day, and that only one of the 1000 different impressions is a winning ticket, such as a free item or dollars off of a purchase, as one of many possible examples. This may provide that more users seek to view the splash screen, thus providing more impressions to the other iterations of the splash screen, thus improving the total number of impressions.

In one example embodiment, a communication device has the ability to transmit data through Wi-Fi and Bluetooth and comprises an antenna capable of transmitting and receiving data up to a maximum range, e.g., about 800 m. Within the maximum range, the Wi-Fi is enabled so that wireless devices can download and upload data. A user having a cell phone that is enabled with Wi-Fi, seems to secure access to the internet through a browser. The Wi-Fi tower is enabled a free Wi-Fi area, and the user, by seeking to access the internet is connected to a first splash screen that identifies a message.

The message may include any number of advertisements from text to images, to GIFs to clickable and actionable links, videos, etc. The limit is only upon what may be presented on such device. Upon viewing said splash screen, Wi-Fi access is enabled. After a duration of about 5 minutes of using said free Wi-Fi, a new splash screen is enabled and is on the screen for about 30 seconds.

However, where the cell phone is not enable with Wi-Fi, the network would then seek to connect to the device with Bluetooth. The network would provide a connectivity message to the user. This provides a smaller advertisement to said user. If no Bluetooth is available, then said user is not able to receive a splash screen or a Bluetooth message.

Although embodiments of the invention have been described in considerable detail, those skilled in the art will appreciate that numerous changes and modifications may be made to the embodiments and preferred embodiments of the invention and that such changes and modifications may be made without departing from the spirit of the invention. It is therefore intended that the appended claims cover all equivalent variations as fall within the scope of the invention.

What is claimed is:

1. A long-range Wi-Fi/Bluetooth communication device for delivering content in a network communication system to mobile devices, the device comprising:
a control module comprising a processor and memory;
at least one Wi-Fi communication module connected to the control module, the Wi-Fi communication module comprising a transmitter and a receiver;
at least one Bluetooth communication module connected to the control module, the Bluetooth communication module comprising a transmitter and a receiver;
a network interface connected to the control module, the network interface being configured to transmit and receive content data to and from the network communication system;
at least one antenna configured to transmit radio frequency signals to the mobile devices and receive radio frequency signals from the mobile devices, the at least one antenna being connected to pass the radio frequency signals to and from the at least one Wi-Fi communication module and the at least one Bluetooth communication module,
wherein both the at least one Wi-Fi communication module and the at least one Bluetooth communication module have a maximum range of at least 400 m.

2. The communication device of claim 1, further comprising a housing configured to hold a circuit board on which at least the control module is mounted.

3. The communication device of claim 1, further comprising a router connected to the network interface, the router being configured to wirelessly provide data communication to the network communication system.

4. The communication device of claim 1, wherein the router is an internal component of the communication device.

5. The communication device of claim 1, wherein the communication device comprises at least two Wi-Fi communication modules and at least two Bluetooth communication modules.

6. The communication device of claim 1, wherein the content comprises advertising multimedia content.

7. The communication device of claim 1, wherein both the at least one Wi-Fi communication module and the at least one Bluetooth communication module have a maximum range of at least 800 m.

8. A network communication system for delivering content to mobile devices, the system comprising:
a plurality of long-range Wi-Fi/Bluetooth communication devices according to claim 1, wherein the communication devices are connected to a network; and
a control server connected to the communication devices via the network, the control server comprising a database for storing content to be delivered to the mobile devices, the control server being configured to present a user interface via the network.

9. A method of delivering content from a network communication system to mobile devices using a long-range Wi-Fi/Bluetooth communication device comprising a control module including a processor and memory, at least one Wi-Fi communication module connected to the control module, at least one Bluetooth communication module connected to the control module, the method comprising:
transmitting Wi-Fi and Bluetooth radio frequency signals through at least one antenna to the mobile devices at a maximum range of at least 400 m, the at least one antenna being connected to pass the radio frequency signals to and from the at least one Wi-Fi communication module and the at least one Bluetooth communication module;
receiving radio frequency signals from the mobile devices;
sending, by the Wi-Fi communication module, a connection acceptance to the mobile devices from which a Wi-Fi access request is received in the received radio frequency signals;
sending, by the Bluetooth communication module, a pairing message to the mobile devices from which a Bluetooth pairing request is received in the received radio frequency signals to establish pairing unless a Wi-Fi connection is already established with the Bluetooth-pairing mobile device;
receiving, by the Bluetooth communication module, a pairing acceptance from the Bluetooth-pairing mobile device, the pairing acceptance comprising an identifier of the Bluetooth-pairing mobile device; and
sending, by the Bluetooth communication module, to the Bluetooth pairing mobile device, content retrieved from the memory of the communication device.

10. The method of claim 9, wherein the Wi-Fi and Bluetooth radio frequency signals are transmitted through at least one antenna to the mobile devices at a maximum range of at least 800 m.

11. The method of claim 9, wherein the content is received by the communication device via a network interface connected to the control module, the network interface being configured to transmit and receive content data to and from the network communication system.

12. The method of claim 9, wherein the pairing message is a string of no more than 16 characters.

13. The method of claim 12, wherein the pairing message constitutes an advertisement.

14. The method of claim 9, wherein the content comprises advertising multimedia content.

15. The method of claim 9, further comprising:
generating a handle based at least in part on the identifier of Bluetooth-pairing mobile device;
checking the handle against a database to determine whether the mobile device is opt-in; and
sending content to the mobile device when the checking of the database returns a result indicating that the mobile device is opt-in.

16. The method of claim 15, further comprising storing the generated handle in a queue which is periodically polled for the presence of handles and which forwards a next handle at a top of the queue, when present, for the checking against the database.

17. The method of claim 16, wherein the handles are each forwarded to one of a plurality of concurrent threads for the checking against the database.

18. The method of claim 15, further comprising storing the content in a queue which is periodically polled for the presence of content and which forwards a next content at a top of the queue, when present, for sending to the mobile device.

19. The method of claim 15, further comprising adding the handle to the database if the handle is not already present in the database.

20. A method of claim 9, wherein the content is delivered to the mobile devices through a network communication system comprising a plurality of long-range Wi-Fi/Bluetooth communication devices, the method further comprising:
accepting content entered via a user interface and received at a system server through a network;
storing the content in a database of the system server; and
transmitting content from the system server via the network to at least one of the long-range Wi-Fi/Bluetooth communication devices.
